(19) United States
(12) Patent Application Publication
(10) Pub. No.: US 2026/0084755 A1
(43) Pub. Date: Mar. 26, 2026

(54) Off-Road Vehicle

(71) Applicant: Zhejiang CFMOTO Power Co., Ltd., Hangzhou (CN)

(72) Inventors: Weidong Ding, Hangzhou (CN); Baofeng Zhang, Hangzhou (CN); Xiaolu Jiang, Hangzhou (CN); Jiuneng Long, Hangzhou (CN); Zhibin Cao, Hangzhou (CN)

(21) Appl. No.: 19/403,948

(22) Filed: Nov. 30, 2025

Related U.S. Application Data
(63) Continuation of application No. PCT/CN2024/094966, filed on May 23, 2024.

(30) Foreign Application Priority Data
May 29, 2023 (CN) 202310624919.7

(51) Int. Cl. B62D 23/00; B60R 21/13

(52) U.S. Cl. CPC B62D 23/005; B60R 21/13

(57) ABSTRACT

An off-road vehicle with front and rear seating has right and left connector assembles connecting a front top bar, a B-pillar, a rear top bar, and a middle cross beam of a Roll-Over Protection System (“ROPS”). The connector assembly includes a front top bar connector weld to the front top bar, a B-pillar connector welded to the B-pillar, a rear top bar connector welded to the rear top bar, and a cross beam connector welded to the middle cross beam, which are bolted together using only four bolts. Various inventive aspects strengthen the frame. For instance, the frame includes a rear sloping beam, sloping rearwardly and upwardly, positioned adjacent the rear seating. A rear door is positioned above the rear sloping beam, with its pivot axis toward a rearward end of the rear door, but spaced well in front of a rear post.

### RELATED APPLICATION INFORMATION

The present application is a continuation of PCT/CN2024/094966, filed May 23, 2024 and entitled “All-Terrain Vehicle”, and claims the benefit of priority to Chinese Patent Application No. 202310624919.7, entitled “all-terrain vehicle”, filed with the Chinese Patent Office on May 29, 2023. The entire contents of the above-referenced applications are incorporated herein by reference.

### FIELD

The present invention relates to the field of vehicles, and particularly to off-road vehicles.

### BACKGROUND

Off-road vehicles, as a type of vehicle which is relatively small but with low pressure tires and high suspension travel to thereby provide strong off-road performance and enjoyment, are increasingly favored by consumers. Two types of off-road vehicles, SSV (Side by Side Vehicles) and UTV (Utility Vehicles), mainly refer to vehicles with a semi enclosed cabin beneath a Roll-Over Protection System (“ROPS”).

Off-road vehicles generally include components or parts such as frames, vehicle covers, engines, and front and rear wheels. The frame of an off-road vehicle serves as the main support structure for the vehicle body, and its structural form and arrangement determine the overall strength of the vehicle. When the overall frame of an off-road vehicle is longer such as in off-road, cabined vehicles with front and rear seating, connection strength between the front and rear portions of the frame and ROPS becomes more critical.

### SUMMARY

In order to address the shortcomings of existing vehicles, the present invention provides an off-road vehicle with improved connection strength of the Roll-Over Protection System (“ROPS”) and frame, while still permitting ease of part transportation and assembly.

In a first aspect, the off-road vehicle includes a frame, front and rear seating, a prime mover assembly, a plurality of wheels, a vehicle cover, and a ROPS. The front seating and rear seating is supported by the frame, as is the prime mover assembly. The plurality of wheels receive torque from the prime mover assembly. The ROPS is connected to the frame and extends over the front and rear seating. The ROPS is preferably laterally symmetrical, which each right and left side including a front top bar, a B-pillar, a rear top bar, and a connector assembly, with a middle cross beam extending from the left connector assembly to the right connector assembly. The front top bar extends generally longitudinally to a side of the front seating. The B-pillar is located rearward of the front top bar and extends generally vertically. The rear top bar is located rearward of the front top bar and rearward of a top of the B-pillar and extends generally longitudinally to the side of the rear seating. The middle cross beam is located rearward of the front top bar, forward of the rear top bar, and extends generally transversely. The connector assembly connects a rear end of the front top bar, a top end of the B-pillar, a front end of the rear top bar and a side end of the middle cross beam. The connector assembly includes a front top bar connector connected to the front top bar, a B-pillar connector connected to the B-pillar, a rear top bar connector connected to the rear top bar, and a cross beam connector connected to the middle cross beam. Each of the front top bar connector, the B-pillar connector, the rear top bar connector and the cross beam connector have a plurality of bolt holes. The connector assembly further includes bolts which can be used through the plurality of bolt holes of the front top bar connector, through the plurality of bolt holes of the B-pillar connector, through the plurality of bolt holes of the rear top bar connector and through the plurality of bolt holes of the cross beam connector to the connect the front top bar, the B-pillar, the rear top bar and the middle cross beam.

In another aspect, the frame includes a rear sloping beam positioned adjacent the rear seating. A rear sloping beam angle defined between the rear sloping beam and horizontal is in a range from 3 to 20°, with the rear sloping beam extending rearwardly and upwardly. A rear door is positioned above the rear sloping beam. The rear door pivots to allow passenger ingress and egress access to the rear seating. The rear door has a rear door hinge defining a rear door pivot axis on a rearward end of the rear door.

### BRIEF DESCRIPTION OF THE DRAWINGS

FIG. 1 is a front left perspective view of an off-road vehicle in a preferred embodiment of the present invention;

FIG. 2 is a front left perspective view of the frame and roll-over protection system (“ROPS”) of the off-road vehicle of FIG. 1;

FIG. 3 is a rear left perspective view of the frame and ROPS of FIG. 2;

FIG. 4 is an exploded left upper perspective view of the left joint in the ROPS of FIGS. 1-3;

FIG. 5 is an exploded rear right perspective view of the left joint in the ROPS of FIGS. 1-4;

FIG. 6 is an exploded right perspective view of the left joint in the ROPS of FIGS. 1-5;

FIG. 7 is an exploded right side perspective view of the left joint in the ROPS of FIGS. 1-6, prior to welding the joint components to their respective tubes;

FIG. 8 is an exploded rear left perspective view of the left connector assembly of FIGS. 1-7, without showing the tubes;

FIG. 9 is a top view of the left connector assembly of FIGS. 1-8, without showing the tubes;

FIG. 10 is a rear right perspective view of a top portion of the left B-pillar and the left B-pillar connector in the left joint of FIGS. 1-9;

FIG. 11 is a left side view of the frame and ROPS of FIGS. 2 and 3;

FIG. 12 is an enlarged view of section 12 of FIG. 11;

FIG. 13 is a front left perspective view of a rear seat frame module for use in the frame of FIGS. 2 and 3;

FIG. 14 is a top plan view of the frame of FIGS. 2 and 3;

FIG. 15 is a top plan view inside the cabin of the off-road vehicle of FIG. 1, with an alternative single hand grab bar;

FIG. 16 is a top view of the hand grab bar and surrounding frame components in the frame of FIGS. 2, 3 and 14;

FIG. 17 is a left cross-sectional side view of the hand grab bar of FIGS. 2, 3 and 14-16, shown relative to the top section of the mid post;

FIG. 18 is a side view of a bucket seat used in the off-road vehicle of FIG. 1;

FIG. 19 is a left perspective view of the bottom support stand in the bucket seat of FIG. 18;

FIG. 20 is a top plan view of the bottom support stand of FIGS. 14, 18 and 19;

FIG. 21 is a left side view of the front and rear seats relative to the footrest in the off-road vehicle of FIG. 1;

FIG. 22 is a top plan view of the footrest of FIG. 21;

FIG. 23 is a top plan view showing the footrest of FIGS. 21 and 22 relative to the rear left seat and a portion of the frame of the off-road vehicle of FIG. 1, and also showing a mid post cushion;

FIG. 24 is a left side view of the mid post cushion relative to portions of the frame and vehicle cover of the off-road vehicle of FIG. 1;

FIG. 25 is a right side view of the rear left door and surrounding frame components and vehicle cover of the off-road vehicle of FIG. 1;

FIG. 26 is a right side view of the rear left door support plate relative to surrounding portions of the frame of FIG. 25;

FIG. 27 is a top cross-sectional view showing attachment of the rear door to the frame of the off-road vehicle of FIG. 1;

FIG. 28 is a left side view of the cooling system used in the off-road vehicle of FIG. 1;

FIG. 29 is a left perspective view of a gear shift relative to the supply and return lines in the cooling system of FIG. 28 and relative to the adjacent frame portions;

FIG. 30 is a top plan view of the cooling system of FIG. 28 relative to the front drive shaft of the off-road vehicle of FIG. 1;

FIG. 31 is a perspective view of sealing structure for an electrical wiring harness used in the off-road vehicle of FIG. 1;

FIG. 32 is a front view of the roof of the off-road vehicle of FIG. 1;

FIG. 33 is a left side view of the roof of FIGS. 1 and 32;

FIG. 34 is an enlarged view of part 34 of FIG. 33; and

FIG. 35 is a rear view of the roof of FIGS. 1 and 32-34.

### DETAILED DESCRIPTION

For better understanding of the above objects, features and advantages of the present invention, preferred embodiments will be described in detail below with reference to the accompanying drawings.

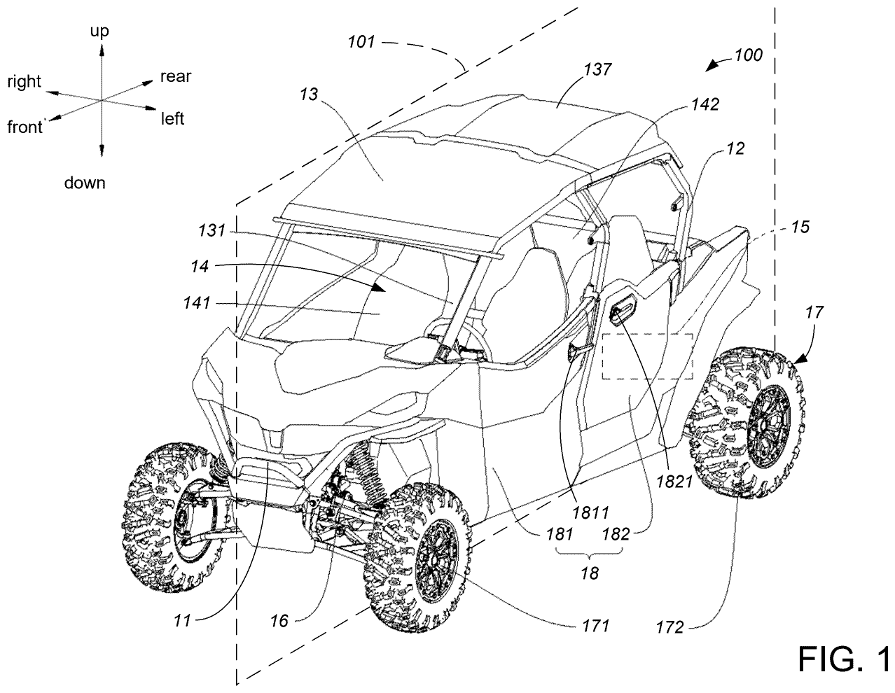

FIG. 1 shows an off-road vehicle 100. The off-road vehicle 100 includes a frame 11, a roll-over protection system (“ROPS”) 12, a vehicle cover 13, seating 14, a prime mover assembly 15 (shown schematically), a drive train 16, and a plurality of wheels 17. For better understanding of the present invention, the directions of “front”, “rear”, “left”, “right”, “up” and “down” are defined in FIG. 1. The frame 11 forms the main framework of the off-road vehicle 100, and other systems and components are directly or indirectly connected to the frame 11. The ROPS 12 is connected to the frame 11 so as to extend over a central section of the frame 11 and define a cabin 131 for the driver and any passengers. The vehicle cover 13 is positioned outwardly relative to the frame 11 and ROPS 12, and is used to cover most of the frame 11 and enclose the cabin 131. The seating 14 is connected to the frame 11 in the cabin 131, including front seating 141 for a driver and at least one passenger to ride on and rear seating 142 for two more passengers to ride on. The prime mover assembly 15 is at least partially connected to frame 11 for providing driving force to the off-road vehicle 100. The drive train 16 is connected to the prime mover assembly 15 and receives the driving torque output by the prime mover assembly 15. The plurality of wheels 17 are at least partially positioned under the frame 11, and receive the driving torque output by the drive train 16 for locomotion of the off-road vehicle 100. The plurality of wheels 17 includes a pair of front wheels 171 positioned at the front of the off-road vehicle 100 and a pair of rear wheels 172 positioned at the rear of the off-road vehicle 100. The off-road vehicles 100 in preferred embodiments of the present invention may be various types of off-road vehicles 100, which includes SSVs and UTVs, and the prime mover assembly 15 may be fuel drive, electric drive, hybrid drive, and/or other forms of drive.

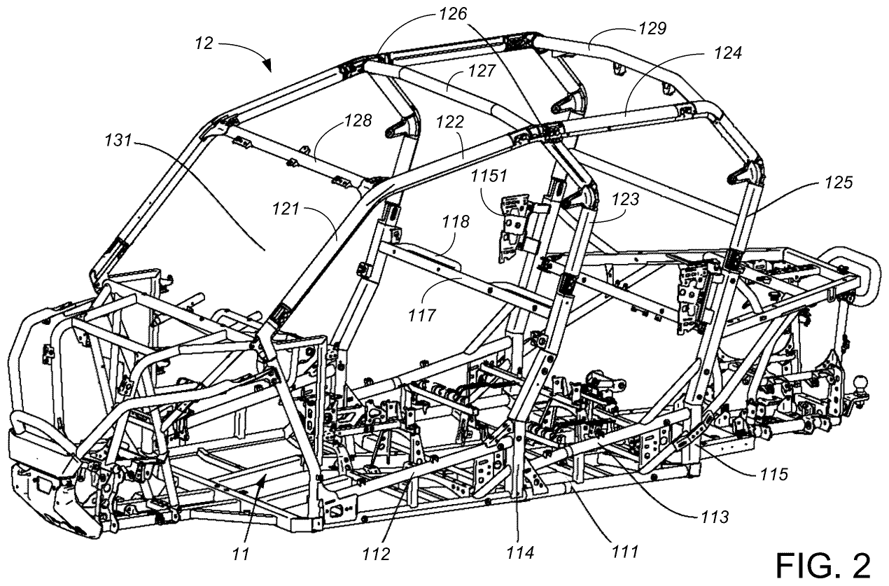

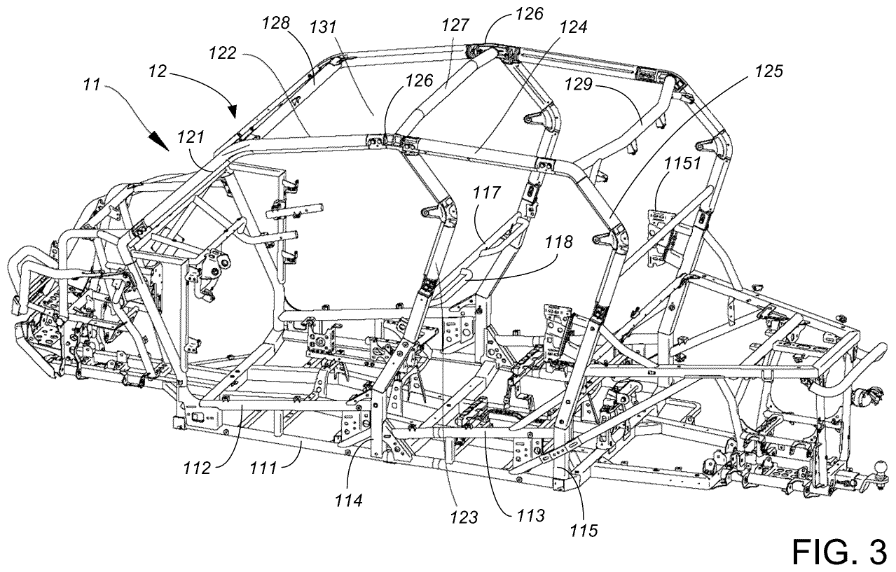

The off-road vehicle 100 is designed as a dual row vehicle with front seating 141 and rear seating 142 in the cabin 131. As shown in FIGS. 2 and 3, the frame 11 and the ROPS 12 are substantially frameworks of joined bars, which in the preferred embodiment are substantially tubes of rigid metal generally connected together by means of welding or fasteners. The ROPS 12 is substantially symmetrical relative to a longitudinal midplane 101, with each of the right and left sides including a front or A-pillar 121, a front top bar 122, a mid or B-pillar 123, a rear top bar 124 and a rear or C-pillar 125. A connector assembly 126 is used to attach the front top bar 122, the B-pillar 123 and the rear top bar 124 together. A middle cross beam 127 extends from the left connector assembly 126 to the right connector assembly 126, and the respective connector assemblies 126 also attach the respective left and right ends of the middle cross beam 127 to the respective (left or right) front top bar 122, B-pillar 123 and rear top bar 124. The B-pillar 123 extends substantially vertically, the front top bar 122 and the rear top bar 124 extend substantially horizontally in the longitudinal direction, and the middle cross beam 127 extends substantially horizontally in the transverse direction. Each of the front top bar 122, the B-pillar 123, the rear top bar 124, and the middle cross beam 127 is manufactured separately and connected together by the connector assembly 126. Compared to forming two or more of the front top bar 122, the B-pillar 123, the rear top bar 124, and the middle cross beam 127 as an integrated tube, separate manufacturing of the front top bar 122, the B-pillar 123, the rear top bar 124, and the middle cross beam 127 reduces the overall volume of the components, each of which can be packaged and transported as a single piece prior to final assembly, thereby reducing difficulty of packaging and shipping transportation of the entire vehicle 100.

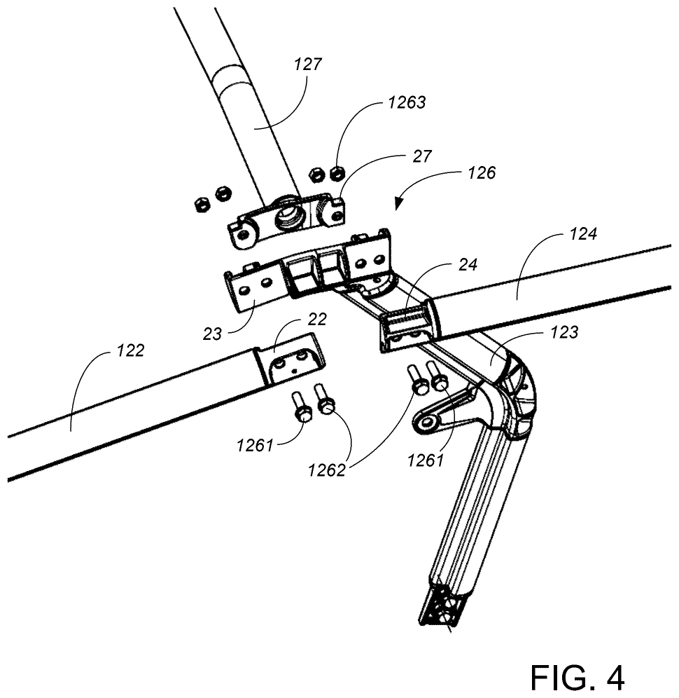

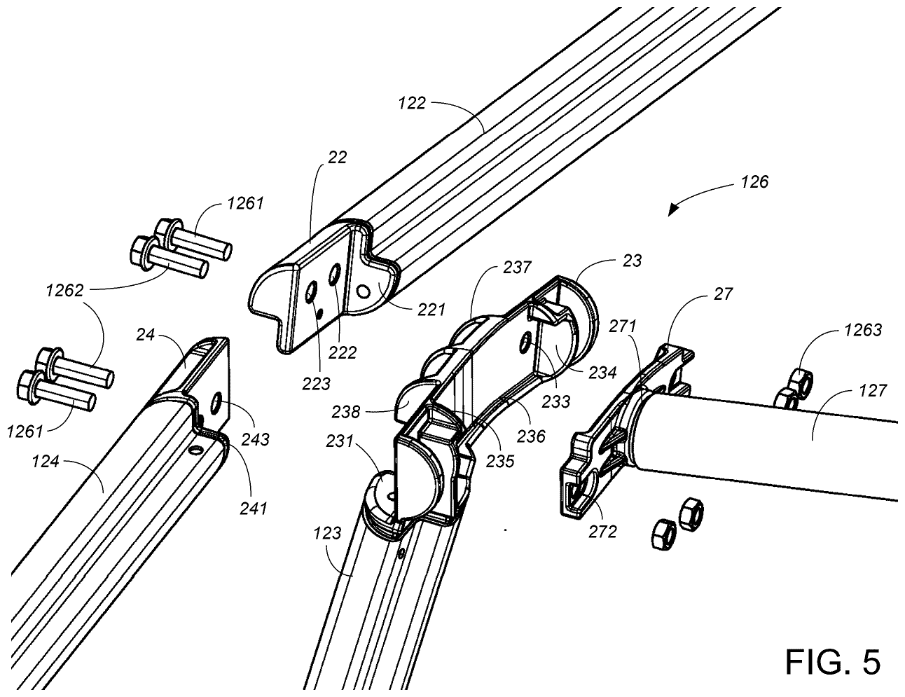

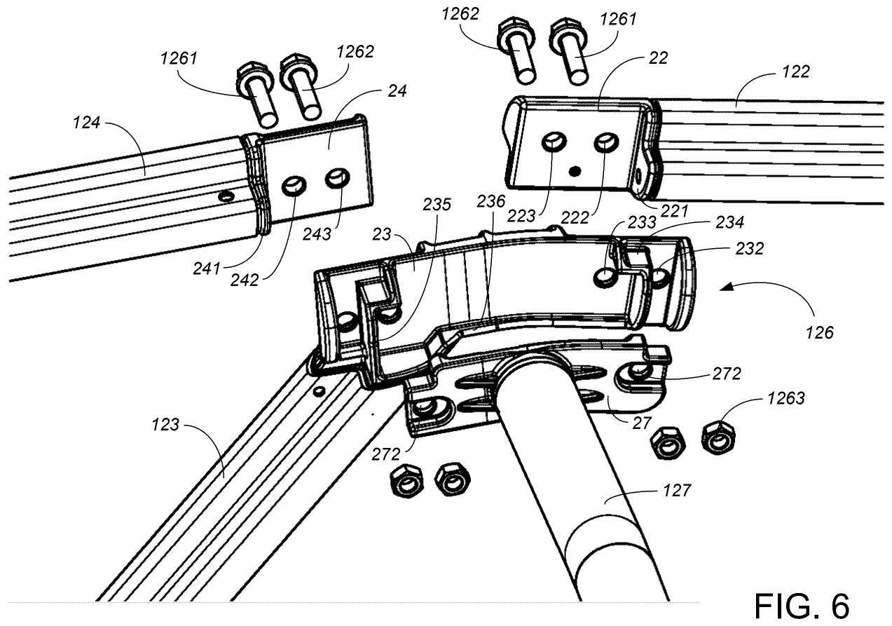

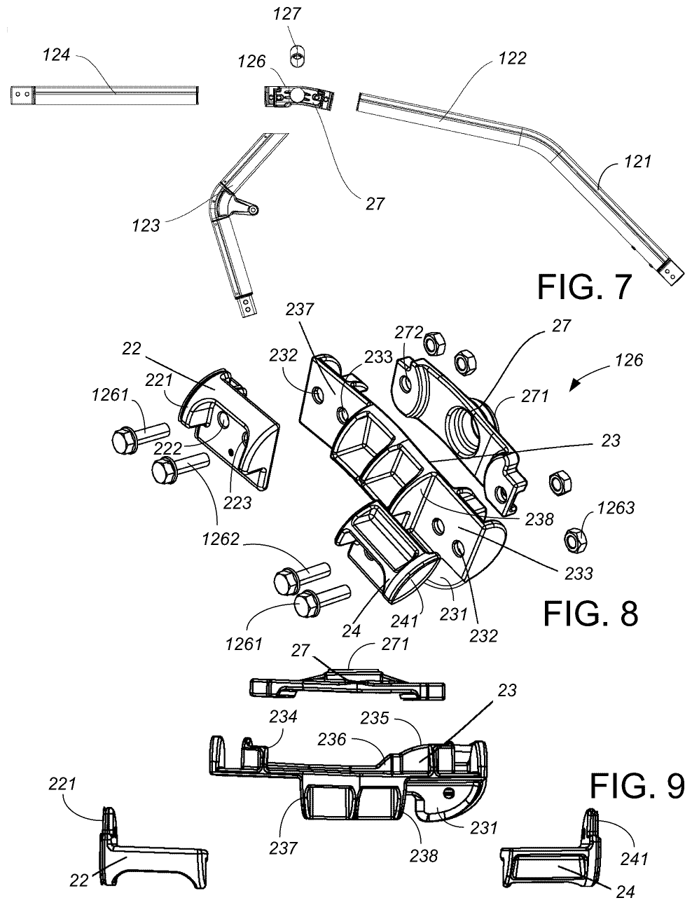

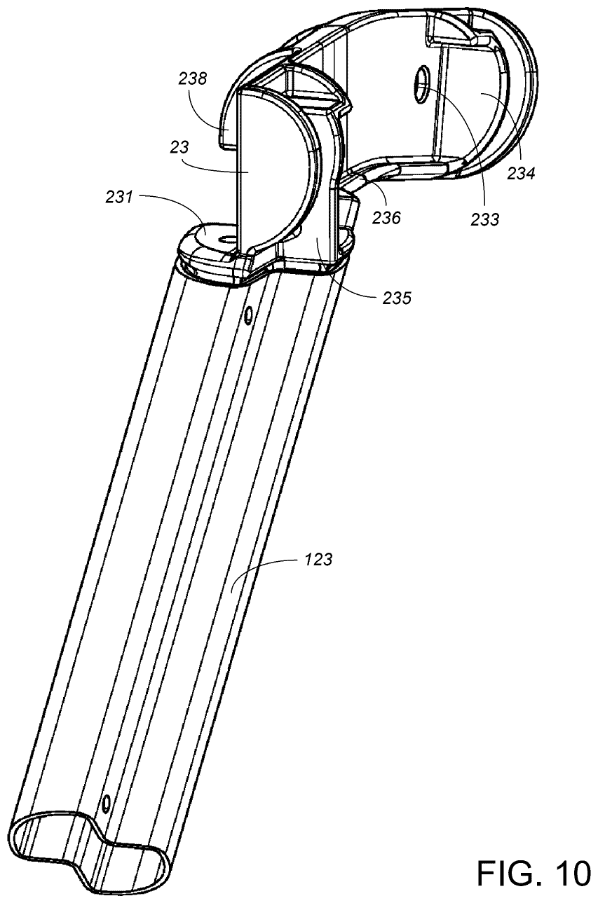

The preferred right and left connector assemblies 126 are formed as collections of mirror image components. As best shown in FIGS. 4-10, each connector assembly 126 includes a front top bar connector 22 for connection to the rear end of the front top bar 122, a B-pillar connector 23 for connection to the top end of the B-pillar 123, a rear top bar connector 24 for connection to the front end of the rear top bar 124, and a cross beam connector 27 for connection to one of the two respective ends of the middle cross beam 127. The B-pillar connector 23 and the cross beam connector 27 each extend substantially longitudinally, over a length greater than the width of the tubing of the B-pillar 123 and greater than the width of the tubing of the cross beam 127. Preferably, the connections between the front top bar connector 22 and the front top bar 122, between the B-pillar connector 23 and the B-pillar 123, between the rear top bar connector 24 and the rear top bar 124, and between the cross beam connector 27 and the middle cross beam 127 are each made by means of factory welding after these components have been manufactured separately. Each of the front top bar connector 22, the B-pillar connector 23, the rear top bar connector 24 and the cross beam connector 27 include a weld shoulder 221, 231, 241, 271 shaped to correspond to the cross-sectional shape of its associated tubing 122, 123, 124, 127 to increase the strength of the welded connection. In particular, the front top bar 122, the B-pillar 123, and the rear top bar 124 and are each formed of tubing having a figure “8” cross-sectional profile best shown in FIG. 10, and the weld shoulders 221, 231, 241 of each of the front top bar connector 22, the B-pillar connector 23, and the rear top bar connector 24 have an exterior shape corresponding at least in part to the figure “8” profile so as to fit inside the associated tubing shape. The middle cross beam 127 has a circular cross-sectional profile, and the weld shoulder 271 of the cross beam connector 27 has a circular exterior shape so as to fit inside the tubing of the middle cross beam 127. Alternatively, the connections between the front top bar connector 22 and the front top bar 122, the B-pillar connector 23 and the B-pillar 123, the rear top bar connector 24 and the rear top bar 124, and the cross beam connector 27 and the middle cross beam 127 could be bolted, adhesively attached or otherwise fixedly attached. As another alternative, the front top bar connector 22 could be integrally formed with the front top bar 122, the B-pillar connector 23 could be integrally formed with the B-pillar 123, the rear top bar connector 24 could be integrally formed with the rear top bar 124, and/or the cross beam connector 27 could be integrally formed with the middle cross beam 127.

During assembly of the ROPS 12 (preferably after shipping to the vehicle dealership, but prior to offering the vehicle 100 for sale to consumers), the preferred embodiment uses four bolts 1261, 1262 to complete the assembly of the connector assembly 126. The bolts 1261, 1262 are preferably oriented horizontally and transversely, inserted from outside in so as to make assembly easier. Front and rear bolts 1261 extend through respective front and rear bolt holes 222, 242 of the front and rear top bar connectors 22, 24 and through front and rear bolt holes 232 of the B-pillar connector 23. Middle bolts 1262 extend through middle bolt holes 223, 243 of the front and rear top bar connectors 22, 24 and through middle bolt holes 233 of the B-pillar connector 23, as well as through bolt holes 272 of the cross beam connector 27. Each of the four bolts 1261, 1262 is preferably secured with a nut 1263. Alternatively, some of the bolt holes (such as bolt holes 232, 272) may be threaded to threadingly receive their respective bolt 1261, 1262.

The front top bar connector 22, the B-pillar connector 23, the rear top bar connector 24 and the cross beam connector 27 all preferably include mating structure to better hold the components of the connector assembly 126 in place prior to insertion and tightening of the four bolts 1261, 1262 and/or nuts 1263. Specifically, on its inwardly facing side, the B-pillar connector 23 includes a front wall 234, a rear wall 235 and a bottom wall 236 all corresponding in shape to the exterior shape of the cross beam connector 27. The cross beam connector 27 can be received and held in its desired position relative to the B-pillar connector 23 by the walls 234, 235, 236 even prior to insertion of the two middle bolts 1262. When the cross beam connector 27 is connected to the B-pillar connector 23, the cross beam connector 27 is substantially positioned in the area enclosed by the walls 234, 235, 236. On its outwardly facing side, the B-pillar connector 23 includes a front abutment wall 237 and a rear abutment wall 238 so the front top bar connector 22 can butt up against the front abutment wall 237 and the rear top bar connector 24 can butt up against the rear abutment wall 238 thereby resulting in alignment of the bolt holes (223 with 233, 224 with 234, 244 with 234, and 243 with 233). When assembled, the front and rear top bar connectors 22, 24 are longitudinally aligned with each other on the outwardly facing side of the B-pillar connector 23. The mating structure which better locates and holds the components of the connector assembly 126 in place during insertion of the four bolts 1261, 1262 allows assembly of each of the four tubes 122, 123, 124, 127 to be accomplished at the dealership with only four bolts 1261, 1262. The preferred design of the connector assembly 126 thus reduces the number of assembly parts and lowers the assembly difficulty (such as at the dealership) while ensuring the connection strength.

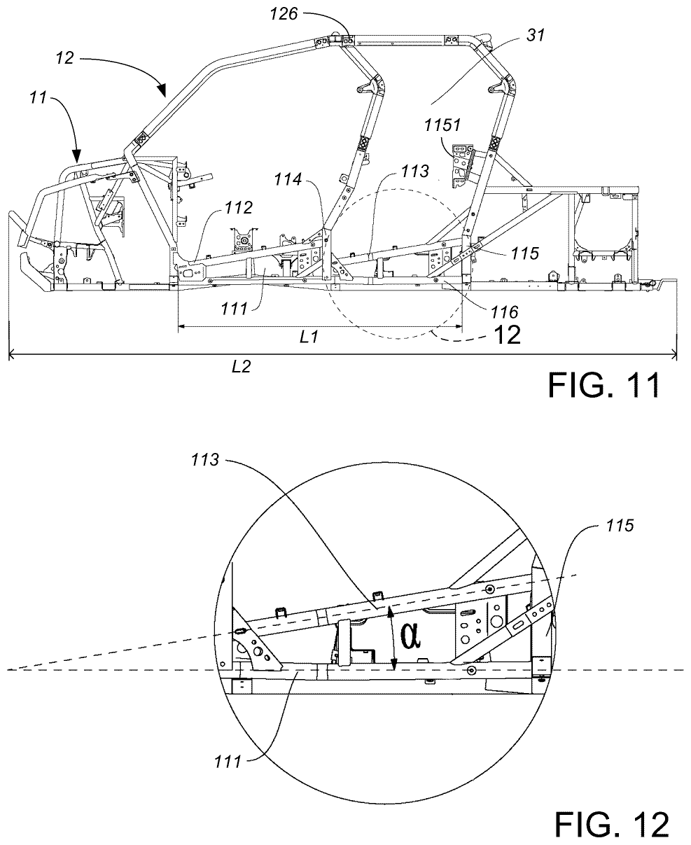

The preferred frame 11 includes at least one pair of longitudinal base beams 111, which extend longitudinally lower than the front seating 141 and the rear seating 142 on right and left sides of the frame 11. As shown in FIG. 11, the frame 11 has a frame length L1 and the longitudinal base beams 111 have a base beam length L2. The base beam length L2 is preferably in the range from 1320 mm to 1985 mm, more preferably in the range from 1485 mm to 1820 mm, and most preferably in the range from 1570 mm to 1735 mm. A base beam frame ratio L2/L1 of the base beam length L2 to the frame length L1 is preferably in the range from 0.37 to 0.56, more preferably in the range from 0.41 to 0.51, and most preferably in the range from 0.44 to 0.49. Having a base beam frame ratio L2/L1 in this preferred range can strengthen the connection strength and enhance the overall rigidity of the frame 11, thereby improving the safety performance of the frame 11 and ROPS 12. The enhanced overall rigidity provided by the longitudinal base beams 111 is particularly beneficial when using the connector assembly 126 to connect each of the four tubes 122, 123, 124, 127 on each side of the vehicle 100.

The frame 11 also includes two pairs of sloping beams, namely right and left front sloping beams 112 positioned on right and left sides of the front seating 141 and right and left rear sloping beams 113 positioned on right and left sides of the rear seating 142. The front ends of the sloping beams 112, 113 are connected on top of the respective longitudinal base beam 111, with the sloping beams 112, 113 angling upwardly and rearwardly therefrom. Specifically, the sloping beams 112, 113 define a sloping beam angle α relative to horizontal which is preferably in the range from 3°to 20°, more preferably in the range from 5°to 15°, and most preferably in the range from 6°to 12°.The rear end of each front sloping beam 112 is connected to a mid post 114 defining the dividing line between the front seating 141 and the rear seating 142. Each front sloping beam 112 with its respective longitudinal base beam 111 and respective mid post 114 have a generally triangular shape which serves to strengthen and increase the stiffness and rigidity of the frame 11. A top end of each mid post 114 is connected to a bottom end of the respective B-pillar 123 of the ROPS 12. The rear end of each rear sloping beam 113 is connected to a rear post 115. Each rear sloping beam 113 with its respective longitudinal base beam 111 and respective rear post 115 also have a generally triangular shape which serves to further strengthen and further increase the stiffness and rigidity of the frame 11. A top end of each rear post 115 is connected to a bottom end of the respective C-pillar 125 of the ROPS 12. While other embodiments have different values for sloping beam angles for the front sloping beam 112 and rear sloping beam 113, the preferred embodiment uses the same angle value for sloping beam angle α for both the front sloping beam 112 and rear sloping beam 113. The enhanced overall rigidity provided by the sloping beams 112, 113 is particularly beneficial when using the connector assembly 126 to connect each of the four tubes 122, 123, 124, 127 on each side of the vehicle 100.

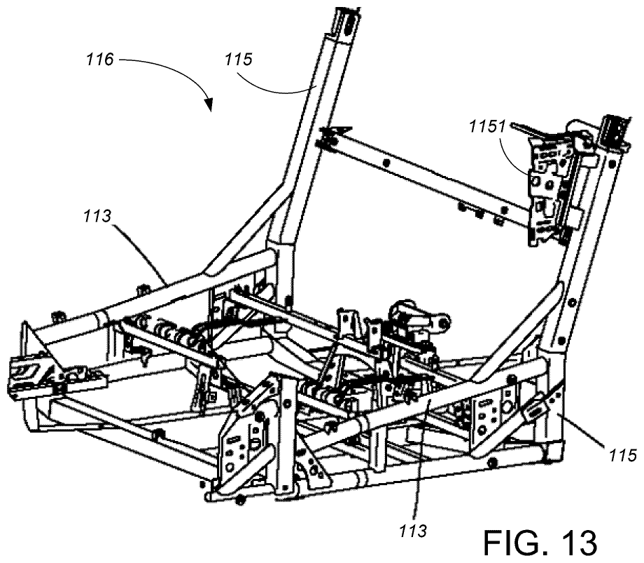

In some embodiments, the frame 11 is designed to be expandable in a modular way, that is, the frame 11 includes a base frame (not separately shown) for front seating 141 and from zero to one or more rear seat frame modules 116 for zero to one or more rows of rear seating 142. The preferred rear seat frame module 116 is shown in FIG. 13. The rear seat frame module 116 is preferably independently assembled prior to being joined to the rest of the frame 11. If two rear seat frame modules 116 are used, the resultant vehicle 100 will have three rows of seating. The use of rear seat frame modules 116 can facilitate the expansion of models of off-road vehicles 100 with minimal increased design and manufacturing costs.

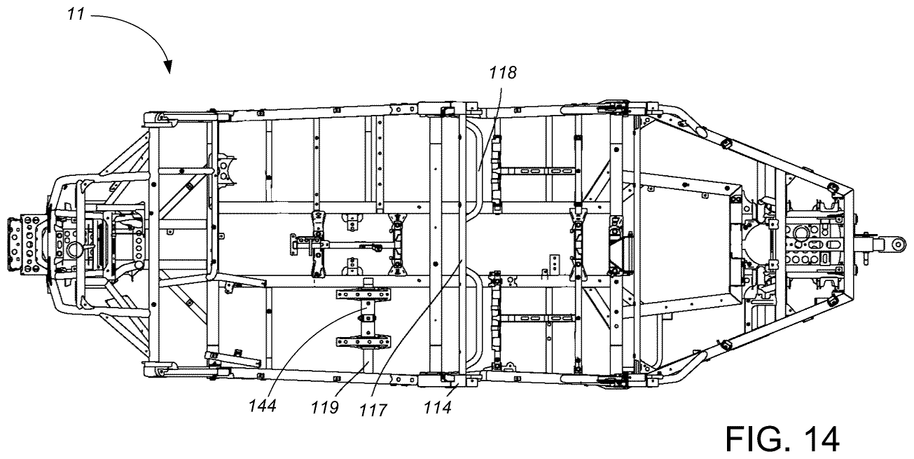

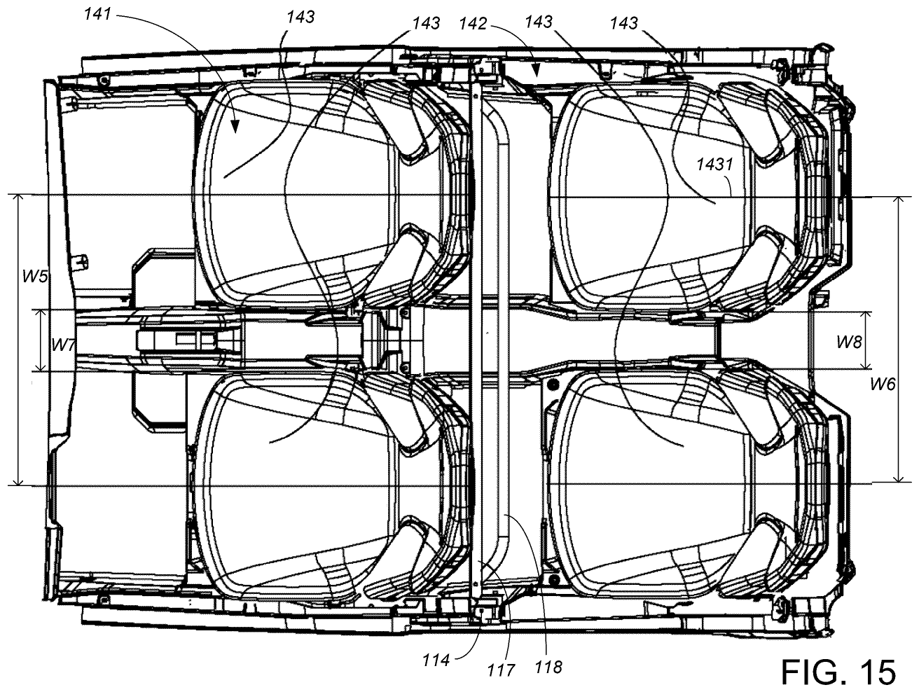

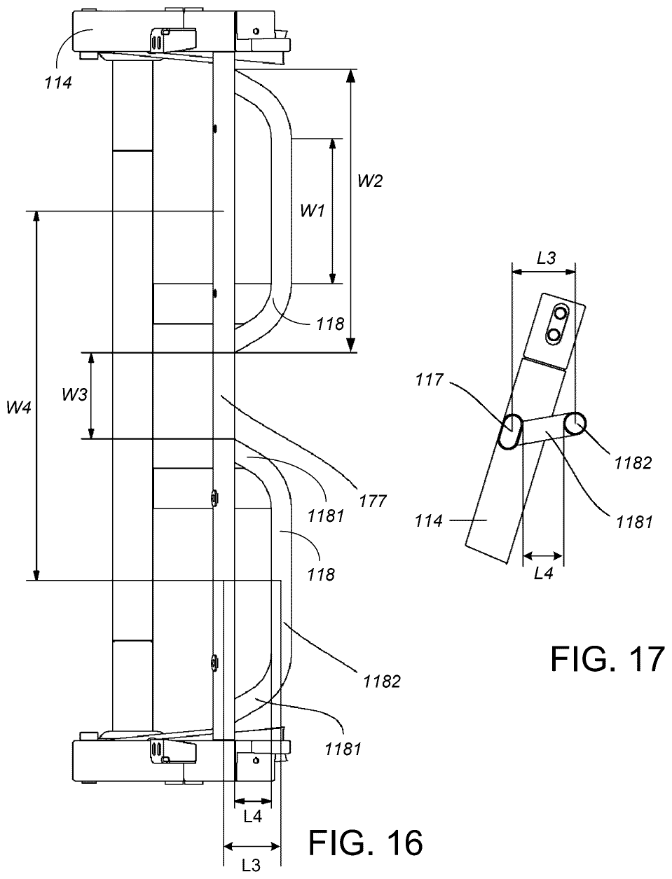

The frame 11 further includes a cross bar 117 running laterally from the top of the left mid post 114 to the top of the right mid post 114. As best shown in FIGS. 14-17, one or two hand grab bars 118 have their ends 1181 connected to the cross bar 117 and have a grip portion 1182 running laterally but spaced behind the cross bar 117 and at generally the same elevation as or slightly higher than the cross bar 117. The grip portion(s) 1182 of the hand grab bar(s) 118 provide a place for each rear passenger to grip their hands, thereby ensuring that they can maintain their body stability by grasping the hand grab bar 118 during the running and turning process of the off-road vehicle 100. The preferred embodiment has right and left hand grab bars 118 as shown in FIGS. 14, 16 and 17, whereas FIG. 15 shows an alternative embodiment with a single hand grab bar 118 for both rear passengers. Having independent right and left hand grab bars 118 avoids rear passengers'hands from interfering with each other, providing better safety for rear passengers. A hand grip spacing distance L3 between the centerline of the cross bar 117 and the centerline of the grip portion 1182 is preferably in the range from 57 mm to 86 mm, more preferably in the range from 64 mm to 78 mm, and most preferably in the range from 67 mm to 75 mm. A hand gap length L4 of the gap between the cross bar 117 and the grip portion 1182 is preferably in the range from 36 mm to 56 mm, more preferably in the range from 41 mm to 51 mm, and most preferably in the range from 43 mm to 49 mm. When the passenger grips the rear armrest assembly, their fingers are generally positioned between the grip portion 1182 and the cross bar 117. When the hand grip spacing distance L3 and the hand gap length L4 are within the above ranges, rear passengers have sufficient grip space for their fingers while the hand grab bars 118 do not excessively encroach into the area of the rear seating 142.

The grip width W1 of each grip portion 1182 is designed according to the gripping needs of the rear passengers. The grip width W1 of each grip portion 1182 is preferably in the range from 270 mm to 406 mm, more preferably in the range from 304 mm to 373 mm, and most preferably in the range from 320 mm to 357 mm. When rear passengers ride, their hands mainly grip on the grip portion 1182, and the grip width W1 of the grip portion 1182 affects the comfort of passengers when gripping. If the grip portion 1182 is too short, the range of left and right movement of the rear passenger's hands will be overly limited, which will affect the grip comfort. If the grip portion 1182 is too long, the rear passenger's hands can slide too far to the left or right.

A grab bar length W2 of the hand grab bar 118 in the transverse direction is slightly larger than the grip width W1. The grab bar length W2 is preferably in the range from 346 mm to 520 mm, more preferably in the range from 389 mm to 476 mm, and most preferably in the range from 410 mm to 455 mm. The spacing-between-grab-bars W3 is designed to take into account the vehicle body size and rear seat lateral spacing of the off-road vehicle 100. The spacing-between-grab-bars W3 is preferably in the range from 149 mm to 225 mm, more preferably in the range from 168 mm to 207 mm, and most preferably in the range from 177 mm to 197 mm. The grab bar midpoint spacing W4, equal to the grab bar length W2 plus the spacing-between-grab-bars W3, is preferably in the range from 495 mm to 745 mm, more preferably in the range from 558 mm to 682 mm, and most preferably in the range from 589 mm to 651 mm.

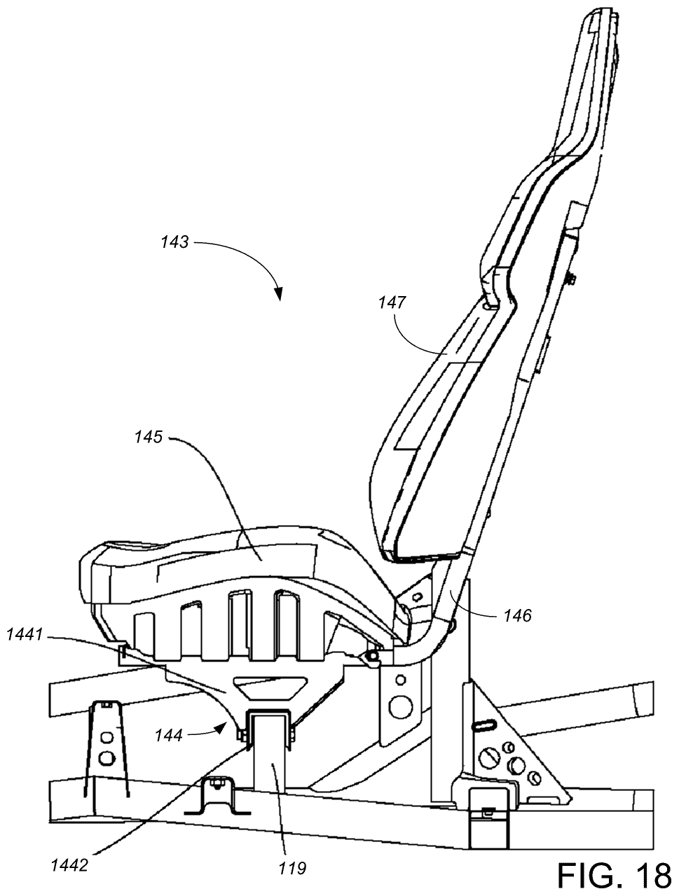

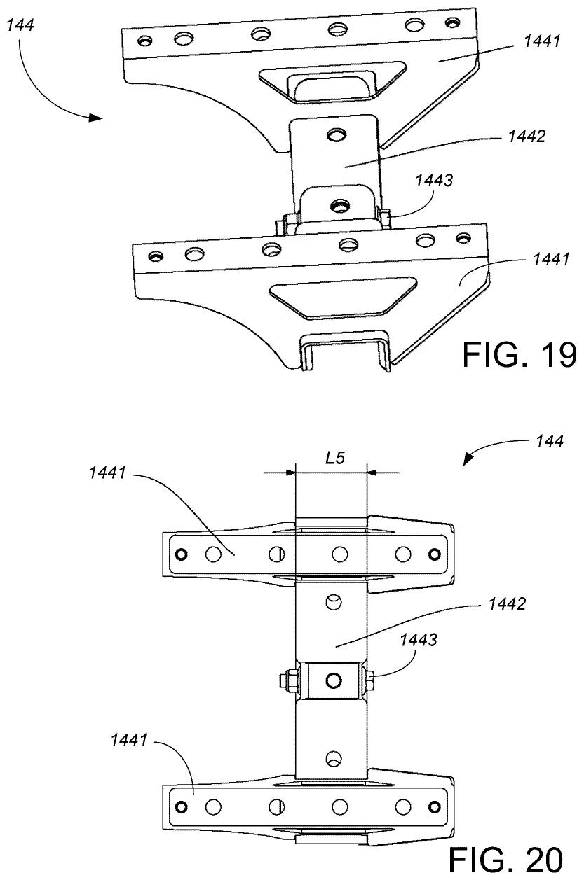

The preferred seats 143 for the off-road vehicle are bucket seats as shown in FIG. 15, and FIG. 18 shows a side view of one of these seats 143. Each seat 143 includes a bottom support stand 144, a seat bottom cushion 145, a back support bar 146 and a back rest cushion 147. As further shown in FIGS. 19 and 20, the bottom support stand 144 includes two seat support runners 1441 fixed to ends of a transverse seat mounting channel 1442 to form a framework. A bottom side of the transverse seat mounting channel 1442 is open, and a seat mounting crossbeam 119 of the frame 11 is received from below into the transverse seat mounting channel 1442, with FIG. 14 showing the location of only the driver's bottom support stand 144. Preferably a single seat mounting crossbeam 119 is used per seat 143, but alternative embodiments use multiple seat mounting crossbeams. The seat support runners 1441 of the bottom support stand 144 are connected to the seat bottom cushion 145 and used to support the seat bottom cushion 145. The preferred seat support runners 1441 are longer at their top where they connect to the seat bottom cushion 145 than at their bottom where they connect to the transverse seat mounting channel 1442, thereby increasing the amount of open space below the seat 143 (particularly toward the floorboard 133) while ensuring the fixing strength of the seat 143 and a large contact area spread with the seat bottom cushion 145. The transverse seat mounting channel 1442 is preferably positioned behind a geometric center of the seat bottom cushion 145, and the preferred seat support runners 1441 extend further forward from the seat mounting crossbeam 119 than rearward from the seat mounting crossbeam 119. Based on a force analysis of passengers sitting on the seat 143, most of their weight is concentrated behind the geometric center of the seat bottom cushion 145. Placing the transverse seat mounting channel 1442 closer to the rear of seat bottom cushion 145 can ensure that it better supports passengers and ensures their safety. The design of the bottom support stand 144 provides for more underseat storage space and rear passenger foot space than prior art seat support arrangements.

As shown in FIG. 20, a channel width L5 of the transverse seat mounting channel 1442 is preferably in the range from 45 mm to 68 mm, more preferably in the range from 50 mm to 63 mm, and most preferably in the range from 53 mm to 60 mm. When mounting the seat 143 in the vehicle, the transverse seat mounting channel 1442 is fitted onto the upper side of seat mounting crossbeam 119, such that the transverse seat mounting channel 1442 is three-sided-sleeved outside the seat mounting crossbeam 119. A fastener 1443 such as a set screw is preferably used to secure the transverse seat mounting channel 1442 to the seat mounting crossbeam 119 at the desired transverse position. While other embodiments utilize the inventive seat support stand 144 for less than all the seats 143, the preferred embodiment uses the seat support stand 144 for all four seats 143.

The back support bar 146 extends upwardly from the bottom support stand 144 to support the back rest cushion 147. The back support bar 146 may be connected to the bottom support stand 144 by welding or by means of fasteners, or they may be integrally formed.

FIG. 15 shows a preferred layout for the front and rear seating 142. The seats 143 in the front seating 141 have a front seating center spacing W5 which is preferably greater than a rear seating center spacing W6 of the seats 143 in the rear seating 142. Having the seats 143 in the rear seating 142 positioned closer to the longitudinal midplane 101 of the off-road vehicle 100 makes it easier for passengers in the rear seating 142 to obtain a forwardly looking view looking between the seats 143 of the front seating 141. The front seating center spacing W5 is preferably in the range from 495 mm to 745 mm, more preferably in the range from 555 mm to 685 mm, and most preferably in the range from 589 mm to 651 mm. The rear seating center spacing W6 is preferably in the range from 485 mm to 735 mm, more preferably in the range from 549 mm to 671 mm, and most preferably in the range from 579 mm to 641 mm. The seating spacing difference W5-W6 between the front seating center spacing W5 and the rear seating center spacing W6 is preferably in the range from 8 mm to 12 mm, more preferably in the range from 9 mm to 11 mm, and most preferably in the range from 9.5 mm to 10.5 mm.

At the same time, there is preferably shorter spacing between the seats 143 of the rear seating 142 than between the seats 143 of the front seating 141. A front seating gap W7 is preferably in the range from 104 mm to 156 mm, more preferably in the range from 117 mm to 143 mm, and most preferably in the range from 123 mm to 136 mm. A rear seating gap W8 is preferably in the range from 96 mm to 144 mm, more preferably in the range from 108 mm to 132 mm, and most preferably in the range from 114 mm to 126 mm. The preferred embodiment utilizes seats 143 in the rear seating 142 which are identical in width to the seats 143 in the front seating 141. Accordingly, the seating gap difference W7-W8 between the front seating gap W7 and the rear seating gap W8 is preferably in the range from 8 mm to 12 mm, more preferably in the range from 9 mm to 11 mm, and most preferably in the range from 9.5 mm to 10.5 mm. Alternative embodiments utilize wider seats 143 in the rear seating 142 for greater rear passenger comfort, providing higher values for the seating gap difference W7-W8

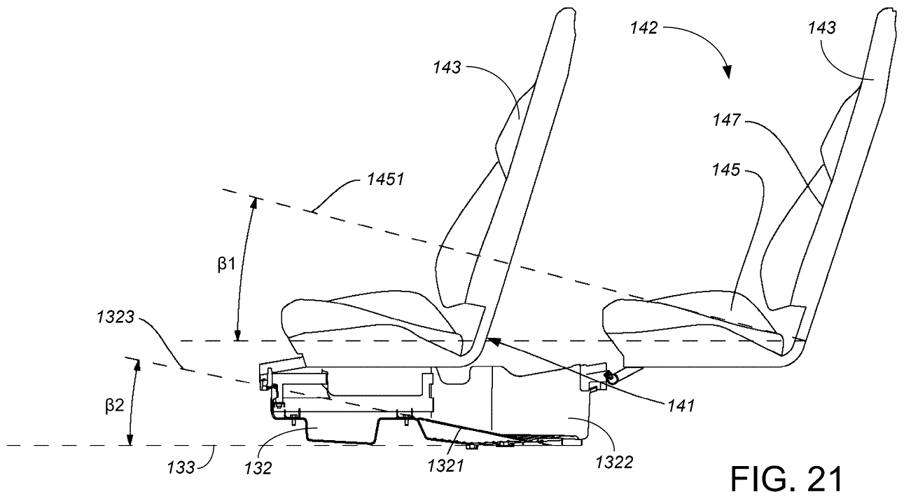

FIG. 21 shows front and rear seating 142 in side view. All four seats 143 are preferably at substantially the same height. In particular, seats 143 in the rear seating 142 are at substantially the same height as seats 143 in the front seating 141, or may even be at a lower height as seats 143 in the front seating 141. By having the seats 143 in the rear seating 142 be no higher than the seats 143 in the front seating 141, it is easier to provide adequate headroom for rear seat passengers.

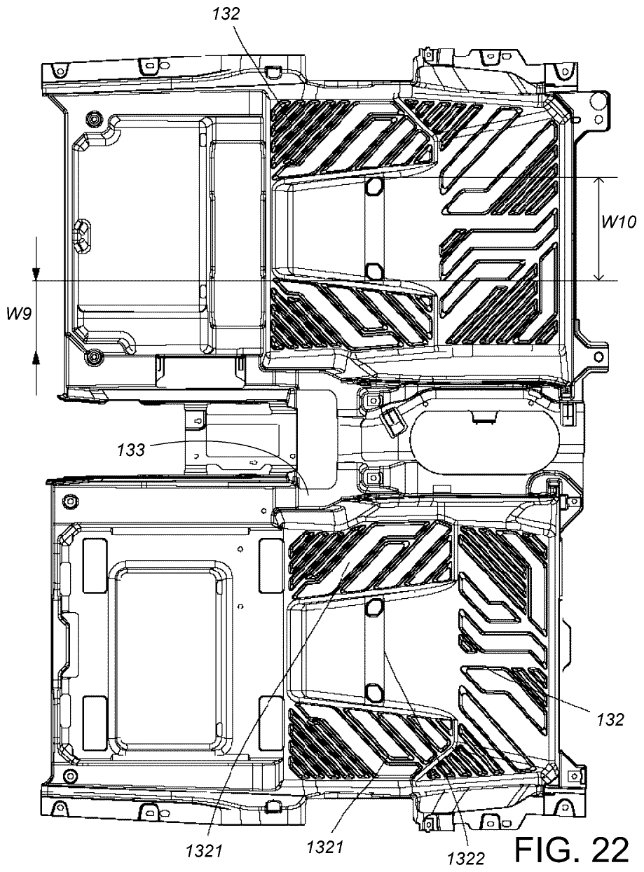

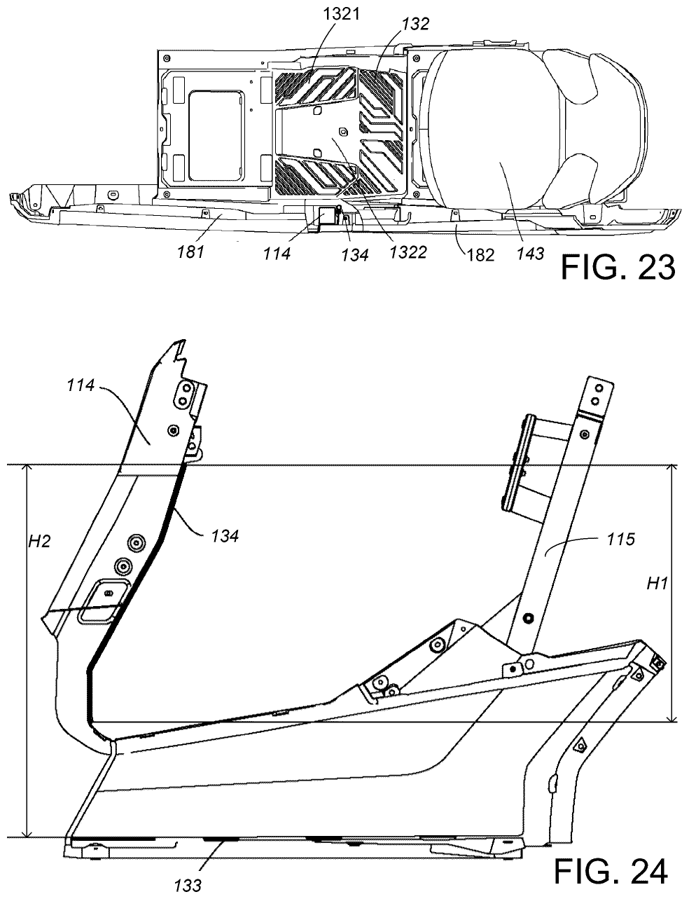

Two footrests 132 are arranged on the floorboard 133 in front of the rear seating 142, one for each rear seat 143. The preferred footrests 132 are shown in FIG. 21 in side view and in FIGS. 22 and 23 in plan view. Each footrest 132 is mainly used to provide support for the passenger's feet. The footrest 132 preferably includes two spaced footrest portions 1321 and a storage portion 1322 positioned between the two footrest portions 1321. Each of the footrest portions 1321 is tilted relative to horizontal. The separated footrest 132 can guide passengers to place their feet in the appropriate position on the footrest 132. The separated footrest 132 can also ensure that passengers'feet are placed in a position with high stability, thereby avoiding passengers from being injured due to collisions caused by two feet being too close during running of the off-road vehicle 100, and also avoiding injuries caused by passengers'feet not being able to get enough traction during braking of the off-road vehicle. The storage portion 1322 expands the storage space of the off-road vehicle 100 and improves the space utilization of the off-road vehicle 100. The storage portion 1322 can be used to hold passengers'luggage and other items, and more importantly, it can also play an important role in maintaining the distance between passengers'feet. The storage portion 1322 is capable of guiding passengers to place each of their feet in correct position.

Each footrest portion 1321 has an average footrest width W9 called out in FIG. 22. The average footrest width W9 is preferably in the range from 80 mm to 130 mm, more preferably in the range from 90 mm to 120 mm, and most preferably in the range from 100 mm to 115 mm. Each storage portion 1322 has an average-between-feet-storage-width W10 also called out in FIG. 22. The average-between-feet-storage-width W10 is preferably in the range from 130 mm to 195 mm, more preferably in the range from 145 mm to 180 mm, and most preferably in the range from 155 mm to 170 mm.

To ensure passenger comfort and enable the back rest cushion 147 to bear more weight of the passenger's torso, the seat bottom cushion 145 of the seat 143 is substantially inclined, with the front of the seat bottom cushion 145 higher than the rear of the seat bottom cushion 145. FIG. 21 calls out a seat bottom incline line 1451, representing the average incline of the seat bottom cushion 145 at the centerline 1431 of the seat 143. The footrest portion 1321 preferably has a similar incline, with the front of the footrest portion 1321 higher than the rear of the footrest portion 1321, to match the angle of the seat bottom cushion 145. FIG. 21 also calls out a footrest incline line 1323, representing the average incline of the footrest portion 1321. The seat bottom incline line 1451 extends at a seat bottom incline angle β1 relative to horizontal. The seat bottom incline angle β1 is preferably in the range from 3 to 16°, more preferably in the range from 7 to 12°, and most preferably in the range from 8.5 to 10.5°. The footrest incline line 1323 extends at a footrest incline angle β2 relative to horizontal. An incline ratio β2/β1 of the footrest incline angle β2 to the seat bottom incline angle β1 is preferably in the range from 0.7 to 2.5, more preferably in the range from 0.7 to 2.0, and most preferably in the range from 0.8 to 1.5.

FIG. 23 also shows the location of the footrest 132 relative to the mid post 114, with a substantial portion of the footrest 132 being forward of the mid post 114. As a result, when rear passengers climb into or out of the off-road vehicle 100, their knees and legs are prone to collide with the mid post 114, which can easily hurt their knees and legs. To avoid/reduce such pain and/or injury, a mid post cushion 134 is provided on the mid post 114. The thickness of mid post cushion 134 is preferably greater than or equal to 3 mm, and the hardness range of mid post cushion 134 is preferably in the range from 10 to 20 Shore A. As called out in FIG. 24, a cushion length H1 of the mid post cushion 134 in the vertical direction is preferably in the range from 200 to 600 mm, while a cushion elevation H2 between the highest point of mid post cushion 134 and the floorboard 133 is preferably in the range from 420 to 640 mm. When the mid post cushion 134 is sufficiently thick and soft and provided at the correct location on the mid post 114, the mid post cushion 134 can provide sufficient cushioning for rear passengers'knees or legs.

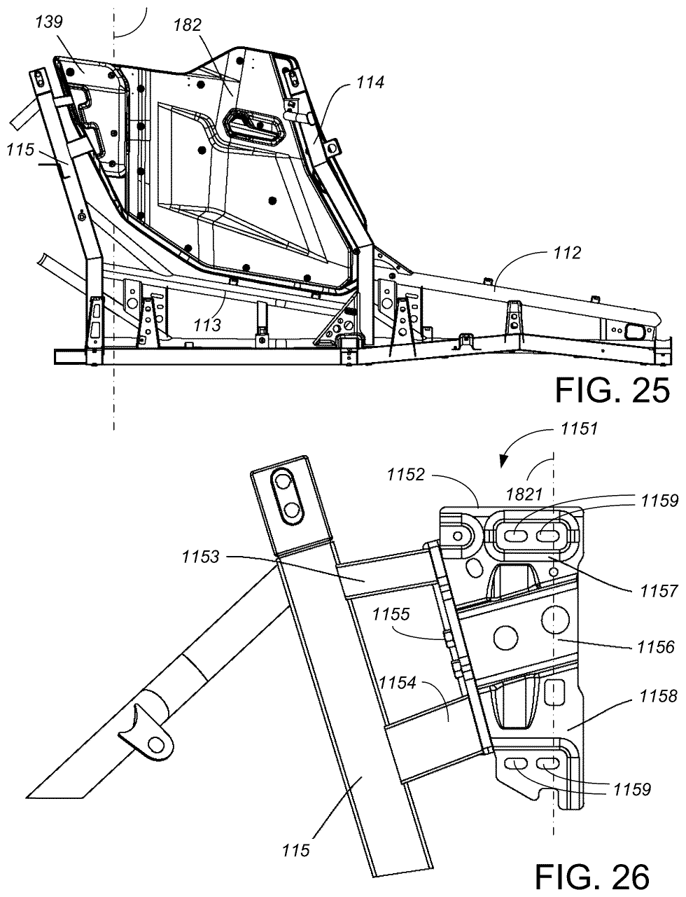

The off-road vehicle 100 includes doors 18 positioned on the sides of the vehicle. The doors 18 include right and left front doors 181 allowing ingress and egress access to the front seating 141 and right and left rear doors 182 allowing ingress and egress access to the rear seating 142 of the off-road vehicle 100. The front doors 181 preferably each pivot about a front door pivot axis (not shown) which is at the front of each front door 181, with an exterior front door latch handle 1811 which is toward the rear of each front door 181 as shown in FIG. 1. The rear doors 182 preferably each pivot about a rear door pivot axis 1821 shown in FIGS. 25 and 26 which is toward the rear of each front door 182, with an exterior rear door latch handle 1822 as shown in FIG. 1 which is toward the front of each rear door 182. The rear door pivot axis 1821 extends generally vertically, and is spaced well forward of the top of the rear post 115 of the frame 11 and well forward of the bottom of the C-pillar 125 of the ROPS 12.

The frame 11 includes a rear door support 1151 for each rear door 182. Each rear door support 1151 includes a rear door hinge support plate 1152 mounted using an upper door support leg 1153 and a lower door support leg 1154 extending forwardly from the rear post 115, so the rear door hinge support plate 1152 extends well forward of the top of the rear post 115. The door support legs 1153, 1154 are preferably formed from metal tubing similar to the rear post 115, spaced at different elevations and extending substantially horizontally and longitudinally from a front side of the rear post 115, so the rear door 182 is cantilevered forward of the rear post 115. The upper and lower door support legs 1153, 1154 are preferably fixed on the rear post 115 by welding, and the rear door hinge support plate 1152 may be fixed on the door support legs 1153, 1154 by welding or by fasteners such as bolts 1155. Connection of the rear door hinge support plate 1152 by fasteners 1155 can facilitate the later maintenance and replacement of the rear door hinge support plate 1152. The rear end of the rear door hinge support plate 1152 is connected to the front end of the door support legs 1153, 1154.

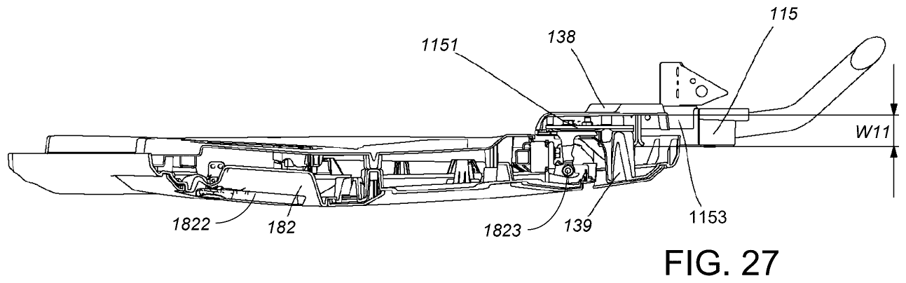

The preferred rear door hinge support plate 1152 includes a boss portion 1156 and reinforced upper and lower wing portions 1157, 1158. The arrangement of the boss portion 1156 and the wing portions 1157, 1158 can appropriately increase the size of the rear door hinge support plate 1152 in the transverse direction, and at the same time enhance the strength of the rear door hinge support plate 1152. Each wing portion 1157, 1158 preferably includes two hinge bolt holes 1159 for attaching the rear door hinge(s) 1823 (shown only in FIG. 27). The rear door hinge support plate 1152 is integrally formed. The rear door hinge support plate 1152 may be made by integral casting or by stamping of steel sheet material. Due to the non-planarity of the boss portion 1156 relative to the wing portions 1157, 1158 and as shown in FIG. 27, the hinge support plate width W11 of the rear door hinge support plate 1152 is considerably thicker than the thickness of its steel sheet material, preferably in the range from 43 mm to 66 mm, more preferably in the range from 43 mm to 60 mm, and most preferably in the range from 43 mm to 58 mm. Rear door interior trim 138 is connected to the inner side of the rear door hinge support plate 1152, and rear door exterior trim 139 is connected to the outer side of the rear door hinge support plate 1152.

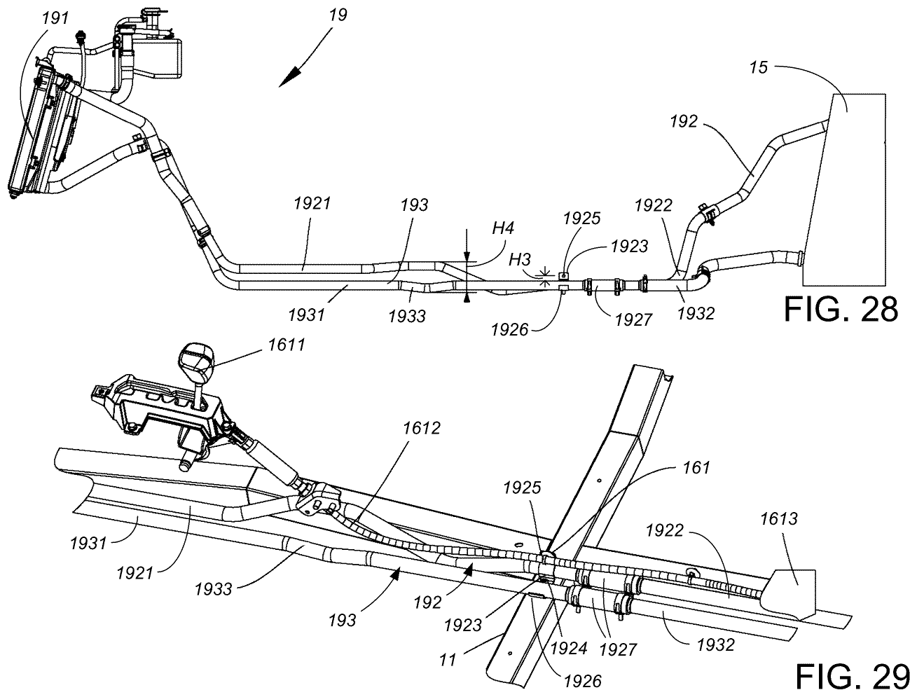

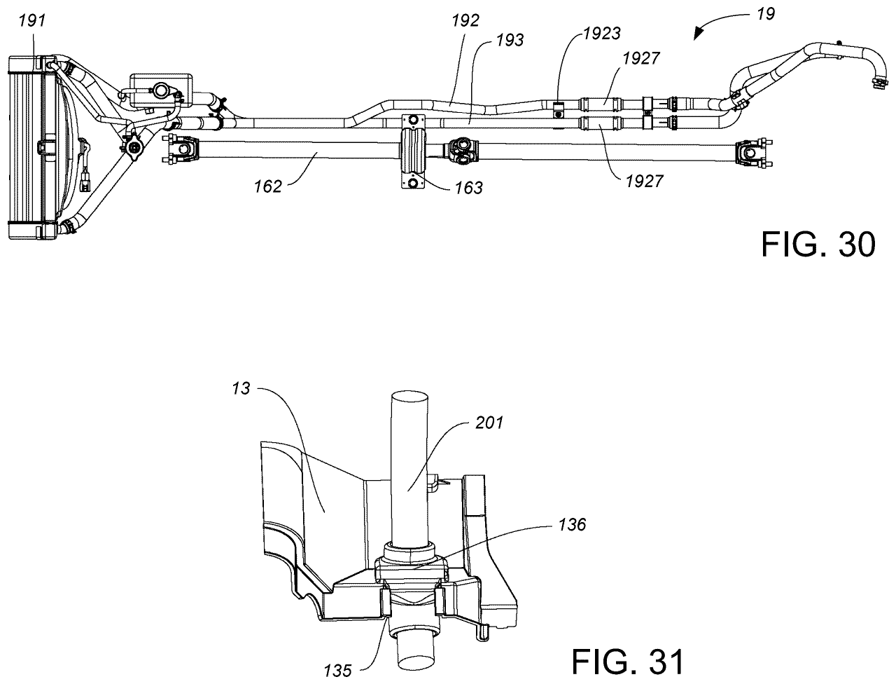

The off-road vehicle 100 further includes a cooling system 19, which helps remove heat from the prime mover assembly 15. As shown in FIGS. 28 and 30, the cooling system 19 includes a radiator 191 preferably positioned at the front of the off-road vehicle 100. A coolant supply pipeline 192 and a coolant return pipeline 193 run longitudinally from the radiator 191 to the prime mover assembly 15, under the cabin 131 of the off-road vehicle. The coolant supply pipeline 192 has a front supply line portion 1921 running longitudinally under the front seating 141 and a rear supply line portion 1922 running longitudinally under the rear seating 142. The coolant return pipeline 193 has a front return line portion 1931 running longitudinally under the front seating 141 and a rear return line portion 1932 running longitudinally under the rear seating 142. The front supply line portion 1921 and the front return line portion 1931 are substantially parallel to each other, preferably at two different elevations which are vertically aligned. The rear supply line portion 1922 and the rear return line portion 1932 are substantially parallel to each other, preferably at the same elevation. Running the rear supply line portion 1922 and the rear return line portion 1932 at the same elevation helps reduce the space required for the cooling system 19 under the rear seating 142.

As shown in FIG. 29, the off-road vehicle 100 further includes a gear shifter 161, which includes a shifter control lever 1611, a shift cable 1612 and a gearbox 1613 (shown schematically) provided as part of the drive train 16 of the off-road vehicle 100. The forward end of the shift cable 1612 is connected to the shifter control lever 1611, and the rearward end of the shift cable 1612 is connected to the gearbox 1613. In this embodiment, since the prime mover assembly 15 is positioned at the rear of the off-road vehicle 100, the gearbox 1613 is correspondingly positioned at the rear of the off-road vehicle 100. The shifter control lever 1611 is positioned in the cabin 131 of the off-road vehicle 100, and the shift cable 1612 passes through much of the frame 11 of the off-road vehicle 100 in the longitudinal direction.

In order to ensure better arrangement and fixation of the shift cable 1612 in the frame 11, a cable fixing bracket 1923 is mounted on at least one of the coolant supply pipeline 192 and the coolant return pipeline 193. In the preferred embodiment, the cable fixing bracket 1923 is welded to the side of the coolant supply pipeline 192 such as on the rear supply line portion 1922, but other fixing methods and locations can alternatively be used. The cable fixing bracket 1923 is preferably also fixed to the frame 11. In the preferred embodiment, the cable fixing bracket 1923 is connected to the frame 11 using a fastener 1924 such as a bolt or sheet metal screw through a connection hole (not separately shown). The cable fixing bracket 1923 extends away from the coolant supply pipeline 192, and the extension direction of cable fixing bracket 1923 is substantially perpendicular to the extension direction of shift cable 1612. The cable fixing bracket 1923 includes a cable attachment ring 1925, and the shift cable 1612 is secured to the cable fixing bracket 1923 using the cable attachment ring 1925. After fixing the shift cable 1612 to the cable fixing bracket 1923, the shift cable 1612 in the preferred embodiment is positioned vertically above the rear supply line portion 1922 of the coolant supply pipeline 192. A shift cable separation distance H3 of the cable attachment ring 1925 from the coolant supply pipeline 192 is preferably less than or equal to 18 mm, more preferably less than or equal to 16 mm and most preferably less than or equal to 15 mm. Running the rear supply line portion 1922 and the rear return line portion 1932 at the same elevation helps provide the vertical space necessary for the shift cable 1612 under the rear seating 142. The cable attachment ring 1925 is preferably oriented so the shift cable 1612 angles relative to the rear supply line portion 1922 of the coolant supply pipeline 192. After fixing the shift cable 1612 to the cable fixing bracket 1923, a forward portion of the shift cable 1612 is substantially positioned on the left side of the rear supply line portion 1922, and then the shift cable 1612 passes diagonally above the rear supply line portion 1922, and then a rearward portion of the shift cable 1612 is substantially positioned on the right side of the rear supply line portion 1922. The preferred cable fixing bracket 1923 also includes a clamping opening 1926 which can be used for securing the rear return line portion 1932 of the coolant return pipeline 193. The preferred cable fixing bracket 1923 thus helps orient and support all of the coolant supply pipeline 192, the coolant return pipeline 193 and the shift cable 1612 relative to the frame 11. The cable fixing bracket 1923 in particular better controls spacing between the shift cable 1612 and the coolant pipelines 192, 193 and frame 11, which can avoid wear and tear and enhance the service life of the shift cable 1612, and also ensure smooth operation of the shift cable 1612.

As shown in FIG. 30, the drive train 16 of the off-road vehicle 100 includes a front drive shaft 162 for transmitting torque from the prime mover assembly 15 and/or gearbox 1613 to the front wheels 171. In the preferred off-road vehicle 100, the coolant pipelines 192, 193 and the shift cable 1612 are arranged to the right of the front drive shaft 162. In order to ensure the stability and durability of the front drive shaft 162, the drive train 16 includes a front drive shaft support seat 163 for supporting the front drive shaft 162, which is connected to the middle of the frame 11. The coolant return pipeline 193 preferably includes a middle dip section 1933 to avoid interference with the front drive shaft support seat 163. A pipeline height difference H4 between the highest point of the front supply line portion 1921 and the bottom of the middle dip section 1933 of the coolant return pipeline 193 is preferably less than or equal to 110 mm, more preferably less than or equal to 100 mm, and most preferably less than or equal to 95 mm.

The preferred coolant pipelines 192, 193 are primarily formed of rigid pipeline sections such as by bending of aluminum alloy pipe material. When the overall lengths of the coolant pipelines 192, 193 are long, especially when greater than 1.8 meters, it is easy to deform or even break due to vibration during the driving of the off-road vehicle 100. In addition, long coolant pipelines are more difficult to transport and maintain in inventory prior to assembly. Accordingly, each of the coolant pipelines 192, 193 preferably also includes an elastic fitting 1927, which may be a rubber fitting. In the preferred embodiment, the elastic fittings 1927 are provided in the rear supply line portion 1922 and the rear return line portion 1932. Segmented designs for the coolant pipelines 192, 193 later joined by elastic fittings 1927 can reduce pre-assembly transportation difficulty, and after assembly can better absorb vibrations and impacts during the running of the off-road vehicle 100.

The electrical system of the off-road vehicle 100 includes one or more electrical wiring harnesses 201, one of which is shown in FIG. 31. Some electrical wiring harnesses 201 need to be arranged through wiring harness holes 135 of the vehicle cover 13. A sealing element 136 is arranged between the electrical wiring harness 201 and the vehicle cover 13. The electrical wiring harness 201 passes through the sealing element 136, which tightly adheres to the outer diameter of the electrical wiring harness 201. For instance, the sealing element 136 can be made of elastic materials, such as rubber or silicone, and mates with the electrical wiring harness 201 with an interference fit. The sealing element 136 serves to isolate the electrical wiring harness 201 from the vehicle cover 13, thereby avoiding damage to the electrical wiring harness 201 while securing the electrical wiring harness 201 to the vehicle cover 13, and can also serve to keep impurities such as water and sediment out of the vehicle interior.

The vehicle cover 13 includes a roof 137 positioned at the top of the off-road vehicle 100 and over the ROPS 12 as shown in FIG. 1. The roof 137 is connected to both right and left front top bars 122, the middle crossbar 127 and both right and left rear top bars 124 of the ROPS 12, as well as to a front crossbar 128 and a rear crossbar 129 of the ROPS 12 called out in FIGS. 2 and 3. As best shown in FIG. 11, the front top bars 122 slope upwardly and rearwardly to the connector assembly 126.

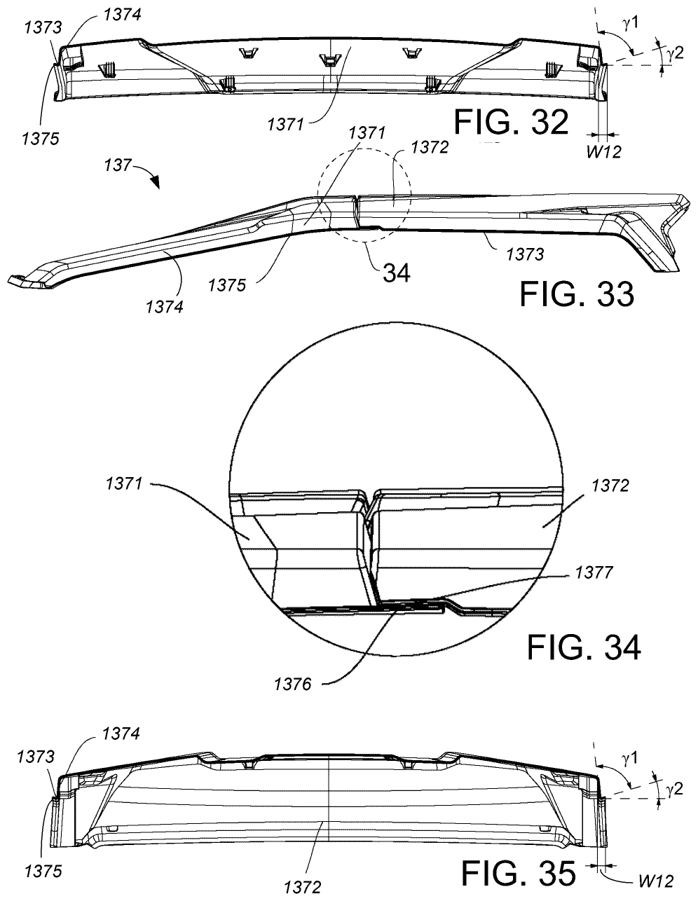

FIGS. 32-35 further show aspects of the roof 137. The roof 137 includes a front roof section 1371 and a rear roof section 1372. The front roof section 1371 is inclined upwardly and rearwardly, while the rear roof section 1372 is substantially horizontal. Both roof sections 1371, 1372 include right and left side grooves 1373 which may be V-shaped or U-shaped. The side grooves 1373 play a role in drainage, guiding the flow of rainwater on the roof 137, so that rainwater can flow in the side grooves 1373 towards the front and rear ends of the off-road vehicle 100, and helping keep rainwater from entering the interior of the off-road vehicle 100. The side grooves 1373 on the front roof section 1371 are sloped to largely match the incline of the front roof section 1371, guiding rainwater forward under the force of gravity. Even though the rear roof section 1372 is substantially horizontal, the side grooves 1373 on the rear roof section 1372 are sloped slightly rearwardly and downwardly, guiding rainwater rearwardly.

Each side groove 1373 has a side edge wall 1374 and an opposing side edge flange 1375, that cooperatively define a groove angle γ1 in front view. The groove angle γ1 is preferably in the range from 75 to 150°, more preferably in the range from 75 to 120°, and most preferably in the range from 75 to 90°. Each side edge flange 1375 is at a side edge flange angle γ2 relative to horizontal. The side edge flange angle γ2 is preferably in the range from 10 to 90°, more preferably in the range from 10 to 60°, and most preferably in the range from 10 to 45°. As called out in FIGS. 32 and 35, each side groove 1373 has a groove width W12. The groove width W12 is preferably in the range from 8 mm to 12 mm, more preferably in the range 9 mm to 11 mm, and most preferably the range 9.5 mm to 10.5 mm. While the preferred embodiment has values for groove angle γ1, for side edge flange angle γ2 and for groove width W12 which are the same for the front roof section 1371 and the rear roof section 1372, alternative embodiments have different values for one or more of groove angle γ1, side edge flange angle γ2 and groove width W12 on the front roof section 1371 as compared to the rear roof section 1372.

The front roof section 1371 and the rear roof section 1372 are preferably connected together by splicing, with the preferred splicing better shown in FIG. 34. The front roof section 1371 includes a front splicing tab 1376 at its rear end, and the rear roof section 1372 includes a rear splicing tab 1377 at its front end. The splicing tabs 1376, 1377 run substantially parallel to each other, with the rear splicing tab 1377 extending over the front splicing tab 1376, and with the slope of both splicing tabs 1376, 1377 matching the slope of the front roof section 1371. The use of the overlaying splicing tabs 1376, 1377 helps prevent rainwater accumulation at the joint.

It should be understood that for those skilled in the art, improvements or transformations can be made based on the above description, and all such improvements and transformations should fall within the scope of protection of the claims attached to this invention.

1. An off-road vehicle comprising
a frame;
front seating and rear seating supported by the frame;
a prime mover assembly supported by the frame;
a plurality of wheels receiving torque from the prime mover assembly;
a vehicle cover at least partially connected to and covering the frame; and
a roll-over protection system (ROPS) supported by the frame and extending over the front seating and the rear seating, wherein the ROPS comprises:
a front top bar extending generally longitudinally to a side of the front seating;
a B-pillar rearward of the front top bar and extending generally vertically;
a rear top bar rearward of the front top bar, rearward of a top of the B-pillar and extending generally longitudinally to the side of the rear seating;
a middle cross beam rearward of the front top bar, forward of the rear top bar, and extending generally transversely; and
a connector assembly connecting a rear end of the front top bar, a top end of the B-pillar, a front end of the rear top bar and a side end of the middle cross beam, the connector assembly comprising:
a front top bar connector connected to the front top bar;
a B-pillar connector connected to the B-pillar;
a rear top bar connector connected to the rear top bar; and
a cross beam connector connected to the middle cross beam;
each of the front top bar connector, the B-pillar connector, the rear top bar connector and the cross beam connector having a plurality of bolt holes, the connector assembly further comprising bolts which can be used through the plurality of bolt holes of the front top bar connector, through the plurality of bolt holes of the B-pillar connector, through the plurality of bolt holes of the rear top bar connector and through the plurality of bolt holes of the cross beam connector to the connect the front top bar, the B-pillar, the rear top bar and the middle cross beam.

2. The off-road vehicle of claim 1, wherein the connector assembly comprises mating structure to better hold at least two of the front top bar, the B-pillar, the rear top bar and the middle cross beam in place with aligned bolt holes prior to insertion and tightening of the bolts.

3. The off-road vehicle of claim 2, wherein the mating structure comprises a plurality of walls on the B-pillar connector which correspond in shape to an exterior of the cross beam connector.

4. The off-road vehicle of claim 1, wherein the front top bar connector and the rear top bar connector are connected against an outer side of the B-pillar connector, and wherein the cross beam connector is connected against an inner side of the B-pillar connector.

5. The off-road vehicle of claim 2, wherein the mating structure comprises a front abutment wall on the B-pillar connector which after assembly is in contact with the front top bar connector and a rear abutment wall on the B-pillar connector which after assembly is in contact with the rear top bar connector.

6. The off-road vehicle of claim 1, wherein the B-pillar is formed of tubing and the middle cross beam is formed of tubing, wherein the B-pillar connector extends longitudinally with a B-pillar connector length greater than a tubing width of the B-pillar, and wherein the cross beam connector extends longitudinally with a cross beam connector length greater than a tubing width of the middle cross beam.

7. The off-road vehicle of claim 1, wherein the front top bar is formed of front top bar tubing, the B-pillar is formed of B-pillar tubing, the rear top bar is formed of rear top bar tubing and the middle cross beam is formed of cross beam tubing, wherein the front top bar connector comprises a front top bar weld shoulder which at least partially matches a cross-sectional shape of the front top bar tubing and is used to weld the front top bar connector to the front top bar, wherein the B-pillar bar connector comprises a B-pillar weld shoulder which at least partially matches a cross-sectional shape of the B-pillar tubing and is used to weld the B-pillar connector to the B-pillar, wherein the rear top bar connector comprises a rear top bar weld shoulder which at least partially matches a cross-sectional shape of the rear top bar tubing and is used to weld the rear top bar connector to the rear top bar, wherein the cross beam connector comprises a cross beam weld shoulder which at least partially matches a cross-sectional shape of the cross beam tubing and is used to weld the cross beam connector to the middle cross beam.

8. The off-road vehicle of claim 1, wherein the frame comprises a longitudinal base beam extending on the side, lower than the front seating and the rear seating, wherein a base beam length of the longitudinal base beam is in a range from 1320 mm to 1984 mm, and wherein a ratio of the base beam length a frame length is in a range from 0.37 to 0.56.

9. The off-road vehicle of claim 1, wherein the frame comprises a front sloping beam positioned adjacent the front seating and a rear sloping beam positioned adjacent the rear seating, wherein sloping beam angles defined between the front sloping beam and horizontal and between the rear sloping beam and horizontal are in a range from 3 to 20°.

10. The off-road vehicle of claim 9, wherein the front sloping beam slopes rearwardly and upwardly, and the off-road vehicle comprises a front door above the front sloping beam, and wherein the rear sloping beam slopes rearwardly and upwardly, and the off-road vehicle comprises a rear door above the rear sloping beam.

11. The off-road vehicle of claim 10, wherein the rear door has a rear door hinge defining a rear door pivot axis on a rearward end of the rear door.

12. The off-road vehicle of claim 11, wherein the rear sloping beam connects to a rear post, wherein the ROPS further comprises a C-pillar extending downwardly from a rear end of the rear top bar, a bottom of the C-pillar connecting to a top of the rear post, and wherein the rear door hinge is mounted from a rear door hinge support plate, the rear door hinge support plate being positioned forwardly of the rear post and being mounted on the rear post with an upper door support leg and a lower door support leg, both the upper door support leg and the lower door support leg extending longitudinally between the rear door hinge support plate and the rear post.

13. The off-road vehicle of claim 10, wherein the rear sloping beam connects to a rear post, wherein the ROPS further comprises a C-pillar extending downwardly from a rear end of the rear top bar, a bottom of the C-pillar connecting to a top of the rear post, wherein the rear sloping beam and the rear post are provided as parts of a rear seat frame module.

14. The off-road vehicle of claim 1, wherein only four bolts are used in the connection assembly to the connect the front top bar, the B-pillar, the rear top bar and the middle cross beam.

15. The off-road vehicle of claim 14, wherein two of the four bolts extend through the front top bar connector, wherein two of the four bolts extend through the rear top bar connector, wherein two of the four bolts extend through the cross beam connector, and wherein four of the four bolts extend through the B-pillar connector.

16. The off-road vehicle of claim 1, wherein the frame comprises a seating mounting crossbeam, and wherein the front seating and the rear seating comprise at least one seat having a bottom support stand with a transverse seat mounting channel, wherein a bottom side of the transverse seat mounting channel is open, and the seat mounting crossbeam is received from below into the transverse seat mounting channel to mount the bottom support stand into the off-road vehicle.

17. The off-road vehicle of claim 1, wherein the vehicle cover comprises a footrest in front of a seat of the rear seating, the footrest comprising two footrest portions positioned on right and left sides of a storage portion.

18. The off-road vehicle of claim 17, wherein the seat of the rear seating has a seat bottom cushion with a front of the seat bottom cushion being higher than a rear of the seat bottom cushion so as to define a seat bottom incline angle having a value in a range from 3 to 16° relative to horizontal, wherein at least one of the footrest portions has a front of the footrest portion higher than a rear of the footrest portion so as to define a footrest incline angle, wherein an incline ratio of the footrest incline angle to the seat bottom incline angle is in a range from 0.7 to 2.5.

19. An off-road vehicle comprising:
a frame;
front seating and rear seating supported by the frame, wherein the frame comprises a rear sloping beam positioned adjacent the rear seating, wherein a rear sloping beam angle defined between the rear sloping beam and horizontal is in a range from 3 to 20°, with the rear sloping beam extending rearwardly and upwardly;
a rear door positioned above the rear sloping beam, the rear door pivoting to allow passenger ingress and egress access to the rear seating, wherein the rear door has a rear door hinge defining a rear door pivot axis on a rearward end of the rear door;
a prime mover assembly supported by the frame;
a plurality of wheels receiving torque from the prime mover assembly;
a vehicle cover at least partially connected to and covering the frame; and
a roll-over protection system (ROPS) supported by the frame and extending over the front seating and the rear seating, wherein the ROPS comprises:
a front top bar extending generally longitudinally to a side of the front seating;
a B-pillar rearward of the front top bar and extending generally vertically;
a rear top bar rearward of the front top bar, rearward of a top of the B-pillar and extending generally longitudinally to the side of the rear seating;
a middle cross beam rearward of the front top bar, forward of the rear top bar, and extending generally transversely; and
a connector assembly connecting a rear end of the front top bar, a top end of the B-pillar, a front end of the rear top bar and a side end of the middle cross beam.

20. The off-road vehicle of claim 19, wherein the rear sloping beam connects to a rear post, wherein the ROPS further comprises a C-pillar extending downwardly from a rear end of the rear top bar, a bottom of the C-pillar connecting to a top of the rear post, and wherein the rear door hinge is mounted from a rear door hinge support plate, the rear door hinge support plate being positioned forwardly of the rear post and being mounted on the rear post with an upper door support leg and a lower door support leg, both the upper door support leg and the lower door support leg extending longitudinally between the rear door hinge support plate and the rear post.
